(19) United States
(12) Patent Application Publication
(10) Pub. No.: US 2011/0181668 A1
(43) Pub. Date: Jul. 28, 2011

(54) Inkjet print head and manufacturing method thereof

(75) Inventors: Ju Hwan Yang, Suwon (KR); Young Seuck Yoo, Seoul (KR); Jae Hun Kim, Seoul (KR); Yun Sung Kang, Suwon (KR); Jae Woo Joung, Suwon (KR)

(73) Assignee: SAMSUNG ELCTRO-MECHANICS CO., LTD., Suwon (KR)

(21) Appl. No.: 12/923,866

(22) Filed: Oct. 12, 2010

(30) Foreign Application Priority Data
Jan. 28, 2010 (KR) 10-2010-0007974

(51) Int. Cl. B41J 2/045; B23P 17/00

(52) U.S. Cl. 347/70; 29/890.1

(57) ABSTRACT

There is provided an inkjet print head including: a body portion including a nozzle ejecting ink, an ink chamber connected to the nozzle so as to supply the ink to the nozzle, and a vibration plate transferring vibrations to the ink chamber and formed of an elastomer; an actuator mounted on the body portion in order to be arranged to correspond to the ink chamber and generating the vibrations transferred to the ink chamber; and a buffer layer allowing for an electrical connection with the actuator and having a Young's modulus greater than that of the body portion.

### CROSS-REFERENCE TO RELATED APPLICATIONS

This application claims the priority of Korean Patent Application No. 10-2010-0007974 filed on Jan. 28, 2010, in the Korean Intellectual Property Office, the disclosure of which is incorporated herein by reference.

### BACKGROUND OF THE INVENTION

1. Field of the Invention

The present invention relates to an inkjet print head and a method of manufacturing the same, and more particularly, to an inkjet print head capable of maximizing the vibratory force of an actuator and a method of manufacturing the same.

2. Description of the Related Art

In general, an inkjet print head converts electrical signals into physical impulses so that ink droplets are ejected through a small nozzle.

In recent years, a piezoelectric inkjet print head has been used in industrial inkjet printers. For example, it is used to directly form a circuit pattern by spraying ink prepared by melting a metal such as gold or silver onto a printed circuit board (PCB). It is also used for creating industrial graphics, or for the manufacturing of a liquid crystal display (LCD), an organic light emitting diode (OLED), and a solar cell.

In general, an inkjet print head includes an inlet and an outlet through which ink in a cartridge is drawn and ejected, respectively, a reservoir storing the ink being drawn, and a chamber transferring the driving force of an actuator so as to move the ink stored in the reservoir toward a nozzle.

According to the related art, an inkjet print head allows for the vibrations of a vibration plate formed of silicon by an actuator so that the ink inside an ink chamber is ejected to the outside. In this case, since the vibration plate is formed of silicon, this causes a reduction in the displacement of the actuator.

Accordingly, the loss of the vibratory force of the actuator is caused by the vibration plate formed of silicon, whereby fine ejection is difficult. In this regard, there is a need for technologies to solve this problem.

### SUMMARY OF THE INVENTION

An aspect of the present invention provides an inkjet print head having improved ink ejection by preventing the loss of the vibratory force of an actuator.

According to an aspect of the present invention, there is provided an inkjet print head including: a body portion including a nozzle ejecting ink, an ink chamber connected to the nozzle so as to supply the ink to the nozzle, and a vibration plate transferring vibrations to the ink chamber and formed of an elastomer; an actuator mounted on the body portion in order to be arranged to correspond to the ink chamber and generating the vibrations transferred to the ink chamber; and a buffer layer allowing for an electrical connection with the actuator and having a Young's modulus greater than that of the body portion.

The buffer layer may be formed of a copper (Cu) plate.

The body portion may include a chamber plate having the ink chamber on a surface thereof. The vibration plate may be mounted on the chamber plate in order to be arranged to correspond to the ink chamber so that the vibration plate may transfer the vibrations generated by the actuator to the ink chamber.

The body portion may include a chamber plate including the ink chamber and formed of an elastomer, and a nozzle plate being in contact with the chamber plate and having the nozzle on a surface thereof.

The body portion may be formed of a thermoset elastomer.

The body portion may include a reservoir storing the ink to be supplied to the ink chamber, and an ink inlet provided for ink injection into the reservoir.

According to another aspect of the present invention, there is provided a method of an inkjet print head, the method including: providing a body portion including a nozzle ejecting ink, an ink chamber connected to the nozzle so as to supply the ink to the nozzle, and a vibration plate transferring vibrations to the ink chamber and formed of an elastomer; forming a buffer layer on a surface of the body portion, the buffer layer having greater rigidity than the body portion; and mounting an actuator on the buffer layer so as to be electrically connected by the buffer layer.

The providing of the body portion may include forming the ink chamber, the nozzle, the vibration plate and a restrictor within a single body.

The providing of the body portion may include bonding the vibration plate to a chamber plate, the vibration plate transferring the vibrations of the actuator and formed of an elastomer and the chamber plate having the ink chamber formed therein.

The providing of the body portion may include bonding a chamber plate to a nozzle plate, the chamber plate having the ink chamber formed therein and formed of an elastomer and the nozzle plate having the nozzle formed therein.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a partial perspective view schematically illustrating an inkjet print head according to an exemplary embodiment of the present invention;

FIG. 2 is a cross-sectional view illustrating the inkjet print head of FIG. 1;

FIGS. 3 and 4 are cross-sectional views schematically illustrating a buffer layer of an inkjet print head according to an exemplary embodiment of the present invention; and

FIGS. 5 and 6 are a perspective view and a cross-sectional view schematically illustrating an inkjet print head according to another exemplary embodiment of the present invention, respectively.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In addition, the same reference numerals will be used throughout the drawings to refer to the same or like elements.

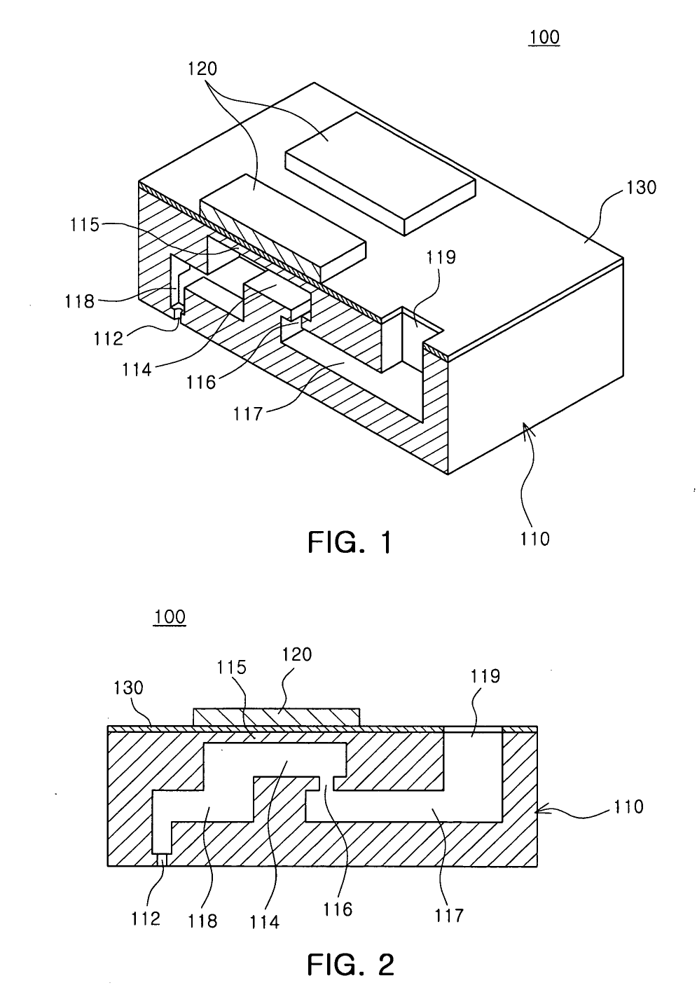

FIG. 1 is a partial perspective view schematically illustrating an inkjet print head according to an exemplary embodiment of the present invention. FIG. 2 is a cross-sectional view illustrating the inkjet print head of FIG. 1.

With reference to FIGS. 1 and 2, an inkjet print head 100 may include a body portion 110, an actuator 120 and a buffer layer 130.

The body portion 110 may be connected to an adapter and an ink tank. In the body portion 110, an ink chamber 114 and a nozzle 112 may be formed such that the ink chamber 114 is connected to the nozzle 112 through which ink is ejected to the outside.

Meanwhile, the body portion 110 may include a vibration plate 115 transferring vibrations to the ink chamber 114 and being formed of an elastomer. That is, the body portion 110 may include the vibration plate 115 forming any one of the walls (an upper wall in the present embodiment) constructing the ink chamber 114, and the vibration plate 115 may be formed of a thermoset elastomer.

Accordingly, the vibration plate 115 formed of the elastomer may reduce the loss of vibratory force to allow for the transfer of the elastic energy of vibrations being increased tenfold or greater, whereby inkjet performance is enhanced.

Meanwhile, as shown in FIGS. 1 and 2, the entire body portion 110 may be formed of an elastomer, in particular, a thermoset elastomer.

Since the body portion 110 is not formed of silicon, but rather an elastomer, a ten-fold increase in the elastic energy of vibrations, or greater, may be achieved, whereby inkjet performance is enhanced.

Also, the body portion 110 may be constructed as a single body including a flow path therein. In this case, the body portion 110 is formed entirely of an elastomer. The body portion 110 may include a reservoir, a restrictor and an ink inlet according to a designer's intentions.

The body portion 110 formed of an elastomer may have a Young's modulus in the range of approximately 0.1 GPa to 10 GPa. Here, the Young's modulus is a value obtained by measuring an ability of withstanding length variations when tension or compressive force is applied to an object in a longitudinal direction, that is, by dividing stress applied in a longitudinal direction by the modulus of deformation.

Therefore, the vibratory force of the actuator 120 becomes large through the body portion 110, and the very large vibratory force may be transferred to the ink chamber 114.

Meanwhile, as shown in FIGS. 1 and 2, the present embodiment describes the body portion 110 as being formed entirely of an elastomer as an example. However, the invention is not limited thereto. The body portion 110, with the exception of the vibration plate 115, may be formed of silicon.

The actuator 120 may have electrodes electrically connected to the upper and lower surfaces thereof. The actuator 120 may be formed of Lead Zirconate Titanate (PZT) ceramic, which is one of piezoelectric materials. Here, a plurality of actuators may be formed on the upper surface of the body portion 110 in such a manner that the actuator 120 may be arranged to correspond to the ink chamber 114.

The actuator 120 is electrically connected to the buffer layer 130 so that it generates the vibratory force. Such a vibratory force generated by the actuator 120 changes the volume of the ink chamber 114. This causes the generation of pressure inside the ink chamber 114 so that the ink inside the ink chamber 114 is ejected to the outside.

However, the actuator 120 is not limited to a piezoelectric actuator. A variety of actuators may be applicable according to a designer's intentions.

The buffer layer 130 may be formed between the body portion 110 and the actuator 120 so as to make an electrical connection with the actuator 120. The buffer layer 130 may have greater rigidity than the body portion 110.

Since the buffer layer 130 is formed of a copper plate, the buffer layer 130 prevents the body portion 110 from being excessively deformed due to the vibratory force of the actuator 120.

Specifically, since the buffer layer 130 is formed of copper, its Young's modulus is approximately 120 GPa, which is greater than that of the body portion 110.

A method of manufacturing the inkjet print head may include providing the body portion 110 including the nozzle 112 through which ink is ejected to the outside, the ink chamber 114 connected to the nozzle 112 so as to supply ink to the nozzle 112, and the vibration plate 115 transferring vibrations to the ink chamber 114 and formed of an elastomer.

Also, the buffer layer 130 is formed on a surface of the body portion 110 such that the buffer layer 130 has greater rigidity than the body portion 110.

Then, the actuator 120 is formed on the buffer layer 130 so as to be electrically connected by the buffer layer 130.

Here, the providing of the body portion 110 may include forming the ink chamber 114, the nozzle 112, the vibration plate 115, the restrictor 116 and the like in a single body. Therefore, the body portion 110 may be constructed as the single body. However, the method of forming the body portion 110 is not limited thereto.

Hereinafter, the elements shown in FIG. 1 will be described in more detail.

An ink inlet 119 is directly connected to a reservoir 117. The reservoir 117 supplies ink to the ink chamber 114 through a restrictor 116.

The ink chamber 114 is disposed under a portion on which the actuator 120 is mounted. The reservoir 117 receives ink from the ink inlet 119 and supplies the ink to the ink chamber 114. The reservoir 117 and the ink chamber 114 are connected to each other through the restrictor 116 to thereby form an ink flow path.

A damper 118 receives the ink ejected from the ink chamber 114 through the actuator 120 and ejects the received ink to the outside through the nozzle 112.

The damper 118 may have a multi-stage configuration by which the amount of ink received from the ink chamber 114 and the amount of ink ejected through the nozzle 112 can be controlled.

Also, an ink storage portion (not shown) injecting ink to the body portion 110 and an adapter portion (not shown) structurally connecting the ink storage portion and the body portion 110 may be further included.

Meanwhile, the vibration plate 115 may form any one of the walls (an upper wall in the present embodiment) constructing the ink chamber 114, and may be formed of an elastomer.

The inkjet print head 100 according to the embodiment shown in FIGS. 1 and 2 employs the body portion 110 formed entirely of an elastomer as an example; however, the invention is not limited thereto. The body portion 110 may be formed of silicon and only the vibration plate 115 may be formed of an elastomer.

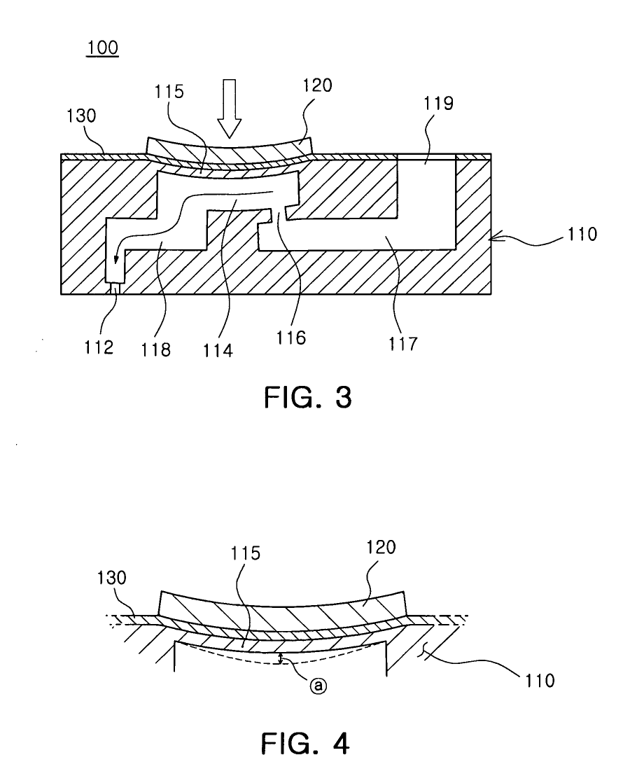

FIGS. 3 and 4 are cross-sectional views schematically illustrating a buffer layer of an inkjet print head according to an exemplary embodiment of the present invention.

With reference to FIGS. 3 and 4, the actuator 120 is electrically connected to the buffer layer 130 and is vibrated by an electrical signal.

Here, as shown in FIG. 3, the actuator 120 is bent towards the ink chamber 114, and the vibration plate 115 forming any one of the walls constructing the ink chamber 114 is also accordingly bent together with the actuator 120.

This bending causes the generation of pressure inside the ink chamber 114 so that the ink inside the ink chamber 114 is ejected to the outside through the nozzle 112.

Here, since the vibration plate 115 is formed of an elastomer, a ten-fold increase in the elastic energy of vibrations, or greater, may be achieved, whereby the vibratory force of the actuator 120 is transferred to the ink chamber 114 without loss.

The buffer layer 130 may be formed of a copper plate. Unless the buffer layer 130 is included, the body portion 110 is deformed up to position (a) depicted by a dotted line as shown in FIG. 4. The buffer layer 130 prevents the body portion 110 from being excessively deformed according to a designer's intentions.

As a result, in the inkjet print head according to this embodiment, since the body portion 110 is formed of the elastomer, the vibratory force of the actuator 120 mounted on a surface of the body portion 110 is transferred to the ink chamber 114 without loss, thereby improving ink ejection.

Also, the inkjet print head and the method of manufacturing the same according to this embodiment includes the buffer layer 130 having greater rigidity than the body portion 110, thereby preventing the body portion 110 formed of the elastomer from being excessively deformed.

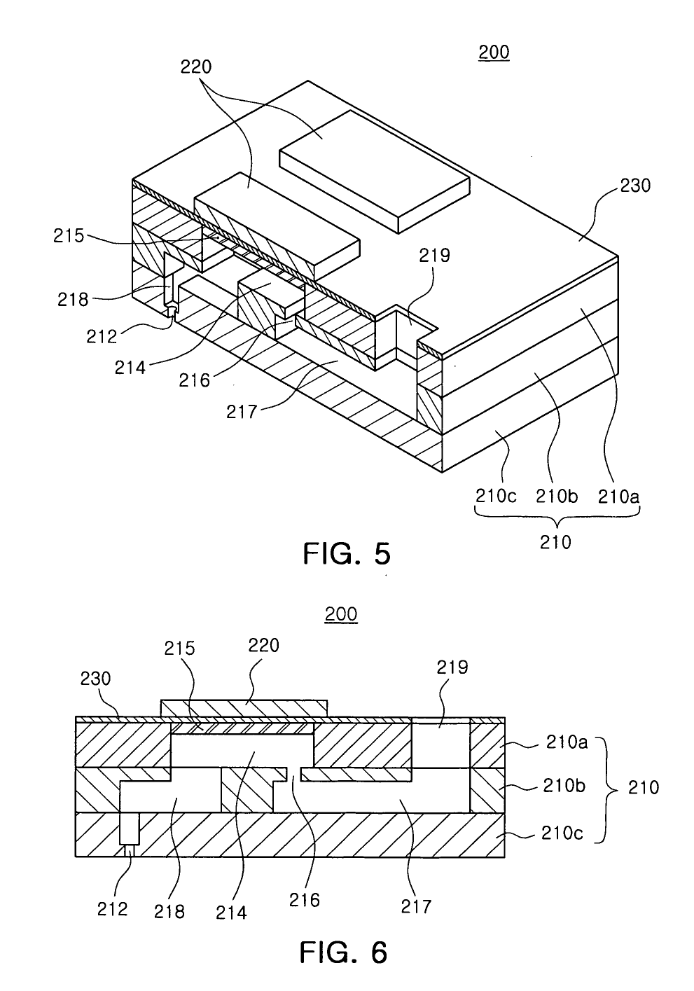

FIGS. 5 and 6 are a perspective view and a cross-sectional view schematically illustrating an inkjet print head according to another exemplary embodiment of the present invention, respectively.

With reference to FIGS. 5 and 6, an inkjet print head 200 may include a body portion 210, an actuator 220 and a buffer layer 230.

The actuator 220 and the buffer layer 230 in this embodiment are substantially the same as those in the aforementioned embodiment, so a detailed description thereof will be omitted.

The body portion 210 may include a chamber plate 210a, an intermediate plate 210b and a nozzle plate 210c.

The chamber plate 210a includes a plurality of ink chambers 214 and ink inlets 219 for drawing ink therethrough. The chamber plate 210a may be formed of an elastomer, particularly a thermoset elastomer.

The chamber plate 210a may include a vibration plate 215 transferring the vibratory force of the actuator 220. The chamber plate 210a may be disposed to be in contact with the vibration plate 215. Like the chamber plate 210a, the vibration plate 215 may also be formed of an elastomer.

The chamber plate 210a may be bonded to the intermediate plate 210b by an adhesive. The intermediate plate 210b may be bonded to the nozzle plate 210c by an adhesive. Here, the chamber plate 210a, the intermediate plate 210b, and the nozzle plate 210c may be formed of an elastomer.

However, the invention is not limited to the structure described in this embodiment. The invention may be varied and modified according to a designer's intentions.

For example, only the vibration plate may be formed of an elastomer. In addition, the body portion may include the chamber plate and the nozzle plate, without the inclusion of the intermediate plate.

The vibration plate 215 and the chamber plate 210a may be integrally formed, or the vibration plate 215 and the chamber plate 210a may be formed as separate elements and then the vibration plate 215 may be bonded onto the chamber plate 210a.

Furthermore, both the vibration plate 215 and the chamber plate 210a may be formed of an elastomer, or only the vibration plate 215 may be formed of an elastomer.

In the inkjet print head and a method of manufacturing the same according to this embodiment, since the body portion 210 is formed of an elastomer, the vibratory force of the actuator 220 mounted on a surface of the body portion 210 is transferred to the ink chamber 214 without loss, thereby improving ink ejection.

As set forth above, in an inkjet print head and a manufacturing method thereof according to exemplary embodiments of the invention, ink ejection is enhanced by transferring the vibratory force of an actuator to an ink chamber without loss in such a manner that the actuator is mounted on a surface of a body portion formed of an elastomer.

Also, an inkjet print head and a manufacturing method thereof includes a buffer layer having greater rigidity than a body portion, thereby preventing the body portion formed of an elastomer from being excessively deformed.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet print head comprising:
a body portion including a nozzle ejecting ink, an ink chamber connected to the nozzle so as to supply the ink to the nozzle, and a vibration plate transferring vibrations to the ink chamber and formed of an elastomer;
an actuator mounted on the body portion in order to be arranged to correspond to the ink chamber and generating the vibrations transferred to the ink chamber; and
a buffer layer allowing for an electrical connection with the actuator and having a Young's modulus greater than that of the body portion.

2. The inkjet print head of claim 1, wherein the buffer layer is formed of a copper (Cu) plate.

3. The inkjet print head of claim 1, wherein the body portion comprises a chamber plate having the ink chamber on a surface thereof, and
the vibration plate is mounted on the chamber plate in order to be arranged to correspond to the ink chamber so that the vibration plate transfers the vibrations generated by the actuator to the ink chamber.

4. The inkjet print head of claim 1, wherein the body portion comprises:
a chamber plate including the ink chamber and formed of an elastomer; and
a nozzle plate being in contact with the chamber plate and having the nozzle on a surface thereof.

5. The inkjet print head of claim 1, wherein the body portion is formed of a thermoset elastomer.

6. The inkjet print head of claim 1, wherein the body portion comprises:
a reservoir storing the ink to be supplied to the ink chamber; and
an ink inlet provided for ink injection into the reservoir.

7. A method of an inkjet print head, the method comprising:
providing a body portion including a nozzle ejecting ink, an ink chamber connected to the nozzle so as to supply the ink to the nozzle, and a vibration plate transferring vibrations to the ink chamber and formed of an elastomer;
forming a buffer layer on a surface of the body portion, the buffer layer having greater rigidity than the body portion; and
mounting an actuator on the buffer layer so as to be electrically connected by the buffer layer.

8. The method of claim 7, wherein the providing of the body portion includes forming the ink chamber, the nozzle, and a restrictor within a single body.

9. The method of claim 7, wherein the providing of the body portion includes bonding the vibration plate to a chamber plate, the vibration plate transferring the vibrations of the actuator and formed of an elastomer and the chamber plate having the ink chamber formed therein.

10. The method of claim 7, wherein the providing of the body portion includes bonding a chamber plate to a nozzle plate, the chamber plate having the ink chamber formed therein and formed of an elastomer and the nozzle plate having the nozzle formed therein.
